(19) United States
(12) Patent Application Publication
(10) Pub. No.: US 2008/0289722 A1
(43) Pub. Date: Nov. 27, 2008

(54) Forest Products Lineal Cutter Assembly and Method

(75) Inventor: Ronald W. McGehee, Ukiah, CA (US)

Correspondence Address: HAYNES BEFFEL & WOLFELD LLP, P O BOX 366, HALF MOON BAY, CA, 94019, US

(73) Assignee: McGehee Development Company LLC, Ukiah, CA (US)

(21) Appl. No.: 12/125,665

(22) Filed: May 22, 2008

Related U.S. Application Data
(60) Provisional application No. 60/939,767, filed on May 23, 2007.

(51) Int. Cl. B27C 9/00; B27M 1/08

(52) U.S. Cl. 144/39; 144/369

(57) ABSTRACT

A forest products lineal cutter assembly comprises a work piece scanning assembly, an outfeed conveyor assembly and a cutting station. The lineal cutter assembly also includes first and second work piece hold down elements above the scan belt at a first exit end of the scan belt and above the outfeed belt at a second entrance end of the scan belt. In some embodiments the first and second work piece hold down elements comprise hold down rollers.

### CROSS-REFERENCE TO OTHER APPLICATIONS

This application claims the benefit of U.S. patent application No. 60/939,767 filed 23 May 2007, Attorney Docket number MGDC 1005-1.

### BACKGROUND OF THE INVENTION

Lineally scanned cutters are used throughout the lumber cutting industry. An example of a lineally scanned cutter is a lineal edger that removes the waste edges off of partially sawn logs. Another example of a lineally scanned cutter is a lineal gang saw configured to gang rip saw the work piece to create two or more sawn work pieces. FIGS. 1 and 2 illustrate a typical lineally scanned edger system. The current state of the art lineally scanned edger system uses a complex and costly work piece transport system to accelerate the work piece towards a scan station, through the scan station and on through the cutting and waste separation stations. This complex and costly method of transporting the work piece has several inherent problems. These include the initial cost of the system, the long term maintenance cost of the system, the environmental impact of the system, and the inaccuracy of the transport system. The accuracy of the transport system in these lineally scanned cutters is very important. Inaccuracies can cause the loss of value and mis-manufactured end products. Examples of the present invention help to address the cost of, the complexity of, and the problems inherent in conventional transport systems.

One example of a conventional forest products lineal cutter assembly is illustrated in FIGS. 1-7 and comprises a work piece transport system including an acceleration station 23 with rollers 1 that accelerate the work piece 2 up to speed in the feed direction 3 of the scan belt 4. Once the work piece 2 is accelerated, it passes through scanner 5 where information about the physical properties of the work piece 2 is measured. This information is used to generate an optimized sawing solution for the work piece 2. The work piece 2 continues on the scan belt 4 towards the work piece clamping station 6 and through the cutting station 7 where the waste edges 8 are cut from the finished work piece 9. It is very important that work piece 2 travels through cutting station 7 in the same relative position as it traveled through scanner 5 on order to have the saw cuts 19 in the proper locations within work piece 2 as predicted by the scanner and optimization computer. The finished work piece 9 and waste edges 8 exit cutting station 7 into an additional work piece clamping station 10, where it passes between hold down rollers 15A and bed rollers 24, and onto the out feed belt conveyor 11. The finished work piece 9 and the waste edges 8 pass over waste separator station 12 where the waste edges 8 are separated from the finished work piece 9. The finished work piece 9 continues on top out feed belt 13 to other processing stations. The waste edges 8 fall into a waste conveying system.

Work piece clamping station 6 has feed chain bed 14 and two hold down rollers 15. Feed chain bed 14 is separated from scan belt 4 by a gap 25, typically 12 to 18 inches; see FIG. 6. This separation causes feeding inaccuracies, also called handoff error, when work piece 2 passes from scan belt 4 to feed chain bed 14. If work piece 2 is warped or bowed as in FIGS. 4-7, the feed inaccuracy is amplified because the transition from scan belt 4 to feed chain bed 14 allows the leading end 16 of work piece 2 to dive over the end 17 of scan belt 4 and crash into end of feed chain bed 14 causing work piece 2 to jump up and, depending upon the angle of impact, move side to side or impact hold down rollers 15 causing side to side movement of work piece 2. This side to side movement can cause cutting station 7 to cut work piece 2 along lines other than the optimized saw lines as predicted be the scanning and optimization computers thereby reducing the value of the finished work piece 9.

The current transport system of FIGS. 1-7 has several transitions from one transport device to the next. If any one of the scan belt 4, feed chain bed 14, out feed work piece clamping station 10 or out feed belt conveyor 11 are out of alignment with the others, it will cause the work piece to be fed in a sideways motion 18, see FIG. 1, along an unpredictable path other than straight along feed direction 3. This sideways motion of the work piece 2 through cutting station 7 causes saw cuts 19 to be along lines other than the optimized saw lines as predicted by the scanner and optimization computers.

The transport system as illustrated in FIGS. 1-7 uses feed chain bed 14 to firmly hold work piece 2 as it passes into cutting station 7. This feed chain bed 14 uses expensive sharp top roller chain 20, sometimes called a feed chain 20, to transport and hold work piece 2 in position as it travels through cutting station 7. This sharp top roller chain 20 runs on guide track 21 and over sprockets 22. Large quantities of lubricating oil are required for sharp top roller chain 20 and chain guide track 21 to reduce friction and wear on sharp top chain 20 and chain guide track 21. This lubricating oil is expensive and can be toxic if it gets into the ground water or creek systems. Sharp top roller chain 20, chain guide track 21 and sprockets 22 wear out regularly and have to be replaced at high cost. These components typically last one year or less and can cost several thousand dollars to replace.

Sharp top roller chain 20 starts out with sharp points to hold work piece 2 firmly. After only a few days of operation, the sharp points of sharp top chain 20 widen out and get flat due to normal wear of transporting work piece 2 through cutting station 7. When this happens, the sharp top chain 20 has a greatly reduced grip on the work piece 2, and work piece 2 can actually slide a little on sharp top chain 20 causing inaccuracies in the transport of work piece 2. These transport inaccuracies can cause cutting station 7 to saw work piece 2 along lines other than the optimized saw lines as predicted by the scanner and optimization computers. Examples of conventional forest products lineal cutter assemblies are sold by CAE Newnes McGehee of Salmon Arm, British Columbia, Canada as Lineal Edge System and Lineal Gang Line System and by United States Natural Resources (often referred to as USNR) of Woodland, Wash., USA. Examples are also disclosed in the following U.S. Pat. No. 6,705,363 entitled Log Processor and Method; U.S. Pat. No. 5,870,936 entitled Edge Trimming and Board Ripping Apparatus and Method; U.S. Pat. No. 5,761,979 entitled Edge Trimming and Board Ripping Apparatus and Method; U.S. Pat. No. 5,722,474 entitled Method and Apparatus for Cutting a Cant into Boards; U.S. Pat. No. 7,017,632 entitled Position-Based Integrated Motion Controlled Curve Sawing; and U.S. Pat. No. 6,062,280 entitled Method and Apparatus for Scanning, Optimizing and Edging a Board with and an Active Edger.

Examples of conventional scanning and optimizing computer systems are sold by United States Natural Resources of Woodland, Wash., USA and CAE Newnes McGehee of Salmon Arm, British Columbia, Canada. Examples are also disclosed in the following U.S. Pat. No. 4,867,213 entitled System for Orienting Logs for Lumber Processing; U.S. Pat. No. 5,884,682 entitled Position-Based Integrated Motion Controlled Curve Sawing; U.S. Pat. No. 6,219,585 entitled Three Dimensional Log Scanning Device for a Log Positioning and Saw System; and U.S. Pat. No. 6,463,402 entitled Infeed Long Scanning for Lumber Optimization.

### BRIEF SUMMARY OF THE INVENTION

An example of a forest products lineal cutter assembly comprises a work piece scanning assembly, an outfeed conveyor assembly and a cutting station. The work piece scanning assembly comprises a scanning conveyor and a scanner, the scanning conveyor having a scan belt with a first entrance end and a first exit end. The scanner is located between the first entrance end and the first exit end. The outfeed conveyor assembly comprises an outfeed belt having a second entrance end. The cutting station is positioned between and adjacent to the first exit end and the second entrance end. The lineal cutter assembly also includes a first work piece hold down element above the scan belt at the first exit end and a second work piece hold down element above the outfeed belt at the second entrance end. In some embodiments the first work piece hold down element comprises a first hold down roller and the second work piece hold down element comprises a second hold down roller.

An example of a method for working on a forest products work piece is carried out as follows. A work piece is directed onto a first entrance end of a moving scan belt of a scanning conveyor. The work piece is moved on the moving scan belt past a work piece scanner and to a first exit end of the scan belt. The work piece is biased against the scan belt at the first exit end. The work piece is moved on the moving scan belt from the first exit end directly to a cutting station, the cutting station being adjacent to the first exit end. The work piece is passed through the cutting station and directly to a second entrance end of an outfeed belt of an outfeed conveyor assembly to create a modified work piece, the cutting station being adjacent to the second entrance end. The modified work piece is biased against the outfeed belt at the second entrance end. The modified work piece is moved along the outfeed belt. In some embodiments the work piece is biased against the scan belt using a first hold down roller. In some embodiments the modified work piece is biased against a second hold down roller.

Other features, aspects and advantages of the present invention can be seen on review of the Figures, the detailed description, and the claims which follow.

### BRIEF DESCRIPTION OF THE DRAWINGS

FIGS. 1-3 are isometric, right side elevational and top plan views of a prior art forest products lineal cutter assembly;

FIGS. 4, 5 and 7 are enlarged isometric, right side elevational and top plan views of a portion of the prior art assembly of FIG. 1 showing the scan belt and work piece clamping station supporting a rough work piece;

FIG. 6 is a large view of a portion of FIG. 5 illustrating how the end of the work piece can improperly engage the sharp top roller chain as it enters the work piece clamping station;

FIGS. 8, 9 and 10 are isometric, right side elevational and top plan views of an example of a forest products lineal cutting assembly made according to the invention, the cutter being a lineal edger type of cutter;

FIGS. 11, 13 and 14 are isometric, right elevational and bottom plan views of an alternative example of a portion of the assembly of FIGS. 8-10, without the waste separator station or top out feed belt, in which the cutter is a lineal gang saw type of cutter; and

FIG. 12 is an enlarged view of the cutting station portion of FIG. 11.

### DETAILED DESCRIPTION OF THE INVENTION

The present invention is directed to an improved work piece transport apparatus and method which provides a greatly simplified approach to transporting work pieces in lineally optimized cutting systems.

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements of the prior art embodiments and the various embodiments of the present invention are commonly referred to with like reference numerals.

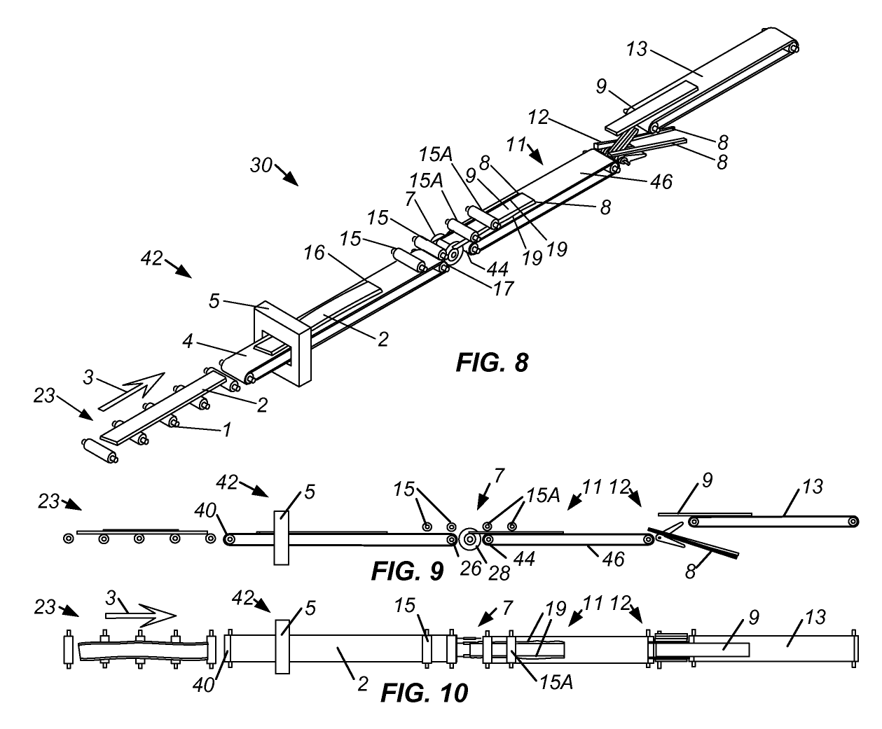

FIGS. 8-10 show an example of a forest products lineal cutter assembly 30 comprising a preferred embodiment of a work piece transport system including an acceleration station 23 with acceleration rollers 1 and rough work piece 2. Rough work piece 2 is accelerated up to speed in the feed direction 3 towards and onto the entrance end 40 of the scan belt 4 of a work piece scanning assembly 40. Rough work piece 2 transported by scan belt 4 passes through scanner 5 of assembly 40 where the physical properties of work piece 2 are measured. Work piece 2 continues on scan belt 4 along feed direction 3 towards hold down rollers 15 which maintain the work piece in the same orientation, passing through the cutting station 7, as the work piece had when it passed through the scanner 5. The exit end 17 of scan belt 4 is positioned directly adjacent to and in close proximity to cutting station 7 and defines a small gap 26, typically 4 to 6 inches, between exit end 17 of scan belt 4 and the cutter or cutters 28 of cutting station 7. This effectively eliminates any feeding inaccuracies or hand off errors associated with the transition between scan belt 4 and feed chain bed 14 of a conventional work piece transport system. Finished work piece 9 and waste edges 8 pass from cutting station 7 directly onto the entrance end 44 of the out feed belt 46 of out feed belt conveyor assembly 11 and under one or more hold down rollers 15A; this maintains the finished work piece 9 and waste edges 8 in the same general orientation when they pass to the waste separation station 12 as the rough work piece 2 had when it passed through the scanner 5.

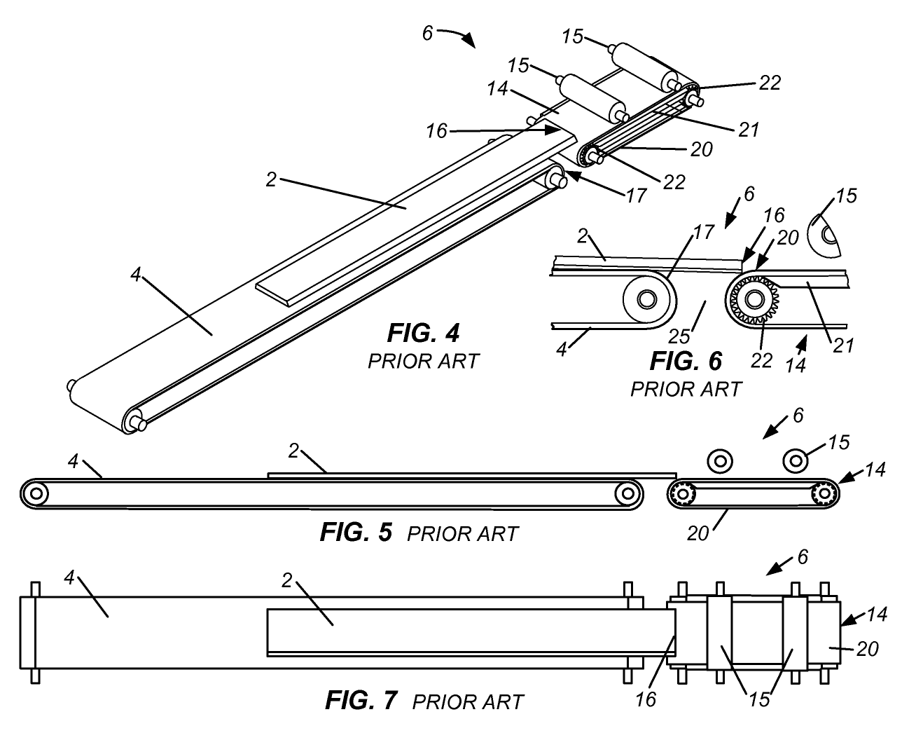

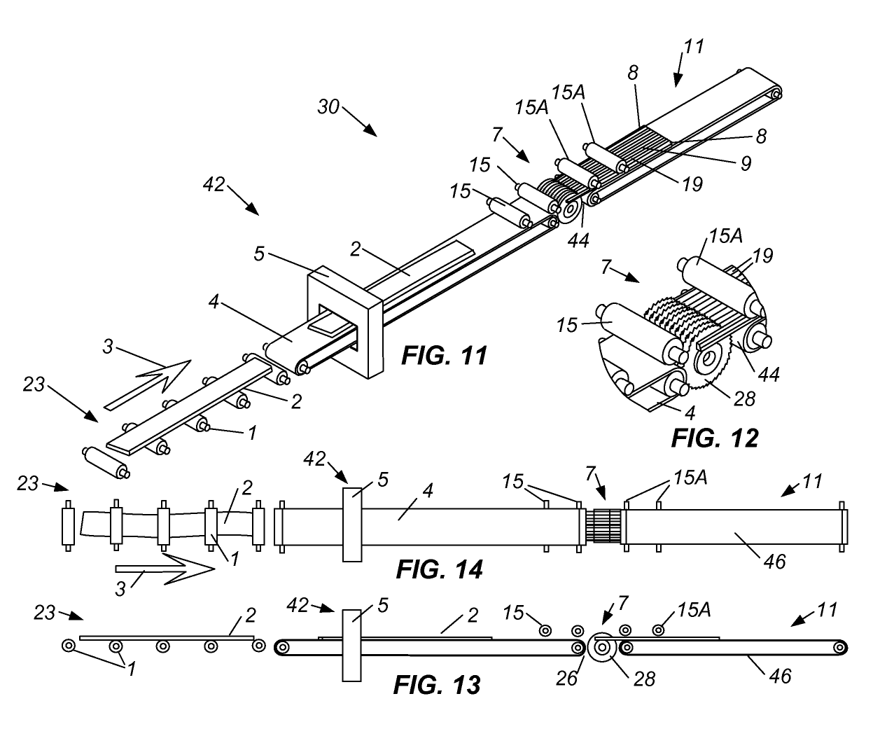

FIGS. 11-14 show another example of a work piece transport system substantially identical to that of FIGS. 8- 10 with the exception of the type of equipment at cutting station 7. Instead of the lineal edger type of cutter 28 of FIGS. 8-10, which removes waste edges 8 leaving a single finished work piece 9, the cutting station 7 of FIG. 4 uses a lineal gang saw type of cutter 28 configured to gang rip saw the rough work piece 2 to create a number of finished work pieces 9 as well as waste edges 8. Other types of lineal scanned cutters may also be used.

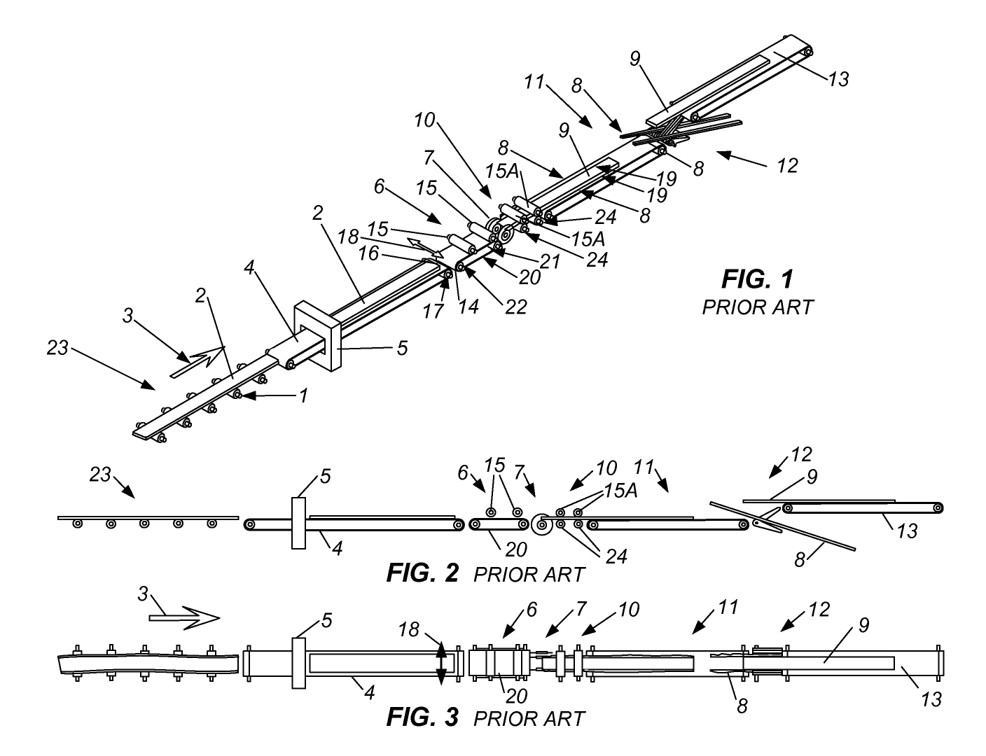

One of the primary advantages of the invention is its simplicity. The invention effectively replaces the chain bed, with its sharp top roller chain 20, chain guide track 21 and sprockets 22, by extending scan belt 4 beneath hold down rollers 15. The invention also replaces bed rollers 24 by extending out feed belt conveyor 11 beneath hold down rollers 15A. The scan belt 4 of the present invention has a much higher coefficient of friction than the feed chain 20 of FIGS. 1-7 to hold the work piece much firmer and maintain better work piece alignment. In conventional systems the work piece feed inaccuracy increases with time as the sharp top chain 20 wears smooth and the chain guide track 21 wears and loses its ability to effectively guide the feed chain 20. The present invention does not have this problem. The reduction of parts and the elimination of expensive sharp top feed chains 20, chain guide tracks 21 and sprockets 22 greatly reduce the initial cost and the long term maintenance cost of the assembly 30. This simplicity also adds to the reliability and life of the system. The need for large quantities of feed chain lubricating oil is eliminated along with the cost and environmental hazards associated with this lubricating oil.

An additional advantage of the invention is the increased feeding accuracy of the work piece. The elimination of transitions from the scan belt 4 to the feed chain bed 14 of conventional systems eliminates all inaccuracies associated with handing the work piece off from one feed section to another. In a conventional system there are several hand off points including the transition from the feed chain bed to the out feed work piece clamping station, and the transition from the out feed station to the out feed belt conveyor. The present invention has no transition before the cutting station 7 assuring that the work piece is in the same orientation passing through the cutting station as it had when it passed the scanner 5.

The above descriptions may have used terms such as above, below, top, bottom, over, under, et cetera. These terms are used to aid understanding of the invention are not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

Any and all patents, patent applications and printed publications referred to above are incorporated by reference.

### LIST OF REFERENCE NUMBERS

1. Acceleration rollers

2. Rough work piece

3. Feed direction

4. Scan belt

5. Scanner

6. Work piece clamping station

7. Cutting station

8. Waste edges

9. Finished work piece

10. Additional work piece clamping station

11. Out feed belt conveyor

12. Waste separator station

13. Top out feed belt

14. Feed chain bed

15. Hold down rollers

15A. Hold down rollers

16. Leading end of work piece

17. End of scan belt

18. Sideways motion

19. Saw cuts

20. Sharp top roller chain

21. Chain guide track

22. Sprocket

23. Acceleration station

24. Bed rollers

25. Gap

26. Gap

28. Cutter

30. Forest products lineal cutting assembly

40. Entrance end of work piece scanning assembly

42. Work piece scanning assembly

44. Entrance end of out feed belt

46. Out feed belt

What is claimed is:

1. A forest products lineal cutter assembly comprising:
a work piece scanning assembly comprising a scanning conveyor and a scanner, the scanning conveyor having a scan belt with a first entrance end and a first exit end, the scanner located between the first entrance end and the first exit end;
an outfeed conveyor assembly comprising an outfeed belt having a second entrance end;
a cutting station positioned between and adjacent to the first exit end and the second entrance end;
a first work piece hold down element above the scan belt at the first exit end; and
a second work piece hold down element above the outfeed belt at the second entrance end.

2. The assembly according to claim 1 further comprising a work piece accelerator station adjacent to the first entrance end.

3. The assembly according to claim 1 wherein the cutting station comprises a lineal edger configured to remove edges from a work piece as a work piece passes from the scan belt to the outfeed belt.

4. The assembly according to claim 1 wherein the cutting station comprises a lineal gang saw configured to gang rip saw a work piece as a work piece passes from the scan belt to the outfeed belt.

5. The assembly according to claim 1 wherein the first work piece hold down element comprises a first hold down roller.

6. The assembly according to claim 1 wherein the second work piece hold down element comprises a second hold down roller.

7. The assembly according to claim 1 wherein the first and second work piece hold down elements comprise a plurality of first and second hold down rollers, respectively.

8. A method for working on a forest products work piece comprising:
directing a work piece onto a first entrance end of a moving scan belt of a scanning conveyor;
moving the work piece on the moving scan belt past a work piece scanner and to a first exit end of the scan belt;
biasing the work piece against the scan belt at the first exit end;
moving the work piece on the moving scan belt from the first exit end directly to a cutting station, the cutting station being adjacent to the first exit end;
passing the workplace through the cutting station and directly to a second entrance end of an outfeed belt of an outfeed conveyor assembly to create a modified work piece, the cutting station being adjacent to the second entrance end;
biasing the modified work piece against the outfeed belt at the second entrance end; and
moving the modified work piece along the outfeed belt.

9. The method according to claim 8 wherein the work piece directing step is carried out using a work piece accelerator station adjacent to the first entrance end.

10. The method according to claim 8 wherein the work piece passing step comprises removing edges from the work piece as a work piece passes from the scan belt to the outfeed belt.

11. The method according to claim 8 wherein the work piece passing step comprises gang sawing a work piece as a work piece passes from the scan belt to the outfeed belt.

12. The method according to claim 8 wherein the scan belt biasing step comprises biasing the work piece against the scan belt using a first hold down roller.

13. The method according to claim 8 wherein the outfeed belt biasing step comprises biasing the modified work piece against a second hold down roller.

14. The method according to claim 8 wherein the modified work piece moving step comprises moving the modified work piece past the second exit end of the outfeed belt.
